(19) United States
(12) Patent Application Publication
(10) Pub. No.: US 2014/0132595 A1
(43) Pub. Date: May 15, 2014

(54) IN-SCENE REAL-TIME DESIGN OF LIVING SPACES

(71) Applicant: MICROSOFT CORPORATION, Redmond, WA (US)

(72) Inventors: Catherine N. Boulanger, Sammamish, WA (US); Matheen Siddiqui, Seattle, WA (US); Vivek Pradeep, Bellevue, WA (US); Paul Dietz, Redmond, WA (US); Steven Bathiche, Kirkland, WA (US)

(73) Assignee: MICROSOFT CORPORATION, Redmond, WA (US)

(21) Appl. No.: 13/676,151

(22) Filed: Nov. 14, 2012

(51) Int. Cl. G06T 15/00; G09G 5/00

(52) U.S. Cl. CPC G06T 15/00; G09G 5/00
USPC 345/419; 345/619; 345/649

(57) ABSTRACT

A display that renders realistic objects allows a designer to redesign a living space in real time based on an existing layout. A computer system renders simulated objects on the display such that the simulated objects appear to the viewer to be in substantially the same place as actual objects in the scene. The displayed simulated objects can be spatially manipulated on the display through various user gestures. A designer can visually simulate a redesign of the space in many ways, for example, by adding selected objects, or by removing or rearranging existing objects, or by changing properties of those objects. Such objects also can be associated with shopping resources to enable related goods and services to be purchased, or other commercial transactions to be engaged in.

### BACKGROUND

The design of interior and exterior living spaces typically involves several steps that are significantly separated in time. A designer reviews a space with a critical eye, makes decisions about changes to be made to that space, purchases goods and then redesigns the space. There is a time gap between viewing the space, making design decisions and viewing the space redecorated. With this time gap, redesigning can become an expensive process if a designer (or customer of designer) is not be pleased with the end result for any of a number of reasons.

There are some software tools that allow three-dimensional models of living spaces to be created, edited and viewed. However, such tools still involve accurate measurement of the space, and disconnect the design process from viewing the actual space.

### SUMMARY

This Summary is provided to introduce a selection of concepts in a simplified form that are further described below in the Detailed Description. This Summary is intended neither to identify key or essential features of the claimed subject matter, nor to limit the scope of the claimed subject matter.

A display renders simulated objects in the context of a scene including a living space, which allows a designer to redesign the living space in real time based on an existing layout. The display can provide a live video feed of a scene, or the display can be transparent or semi-transparent. The live video feed can be displayed in a semi-opaque manner so that objects can be easily overlaid on the scene without confusion to the viewer.

A computer system renders simulated objects on the display such that the simulated objects appear to the viewer to be in substantially the same place as actual objects in the scene. The displayed simulated objects can be spatially manipulated on the display through various user gestures. A designer can visually simulate a redesign of the space in many ways, for example, by adding selected objects, or by removing or rearranging existing objects, or by changing properties of those objects. Such objects also can be associated with shopping resources to enable related goods and services to be purchased, or other commercial transactions to be engaged in.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is an illustration of a user viewing a scene of simulated objects in the context of a scene with corresponding actual objects.

FIG. 2 is a data flow diagram illustrating an example implementation of a design system.

FIG. 3 is a more detailed data flow diagram illustrating an example implementation of user input modules for a design system such as in FIG. 2.

FIG. 4 is a flow chart describing an example operation of the system in FIG. 2.

FIG. 5 is a flow chart describing an example operation of an object recognition system.

FIG. 6 is another illustration of a scene as viewed with a display that includes simulated objects.

FIG. 7 is a block diagram of an example computing device in which such a system can be implemented.

### DETAILED DESCRIPTION

The following section provides an example operating environment in which the environmental design application described herein can be implemented.

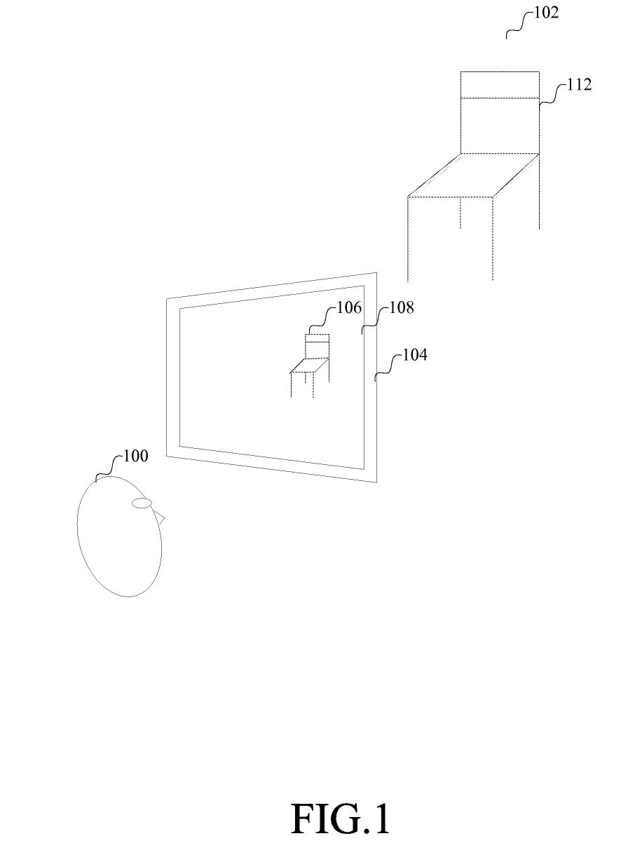

Referring to FIG. 1, an individual 100 views a scene 102 and a display 104. The scene 102 can be any of a number of environments, whether interior (in a building such as an office building or a home), or exterior, such as a garden, patio or deck. The environment can be commercial or residential. Such a scene can contain one or more objects, such as furniture, walls, art work, plants, flooring and the like, that the individual may consider a design feature of the scene.

The display 104 can be a transparent display, allowing the individual to view the scene 102 through the display. The display 104 also can display a live video feed of the scene, thus allowing the individual to view a portion of the scene on the display in the context of the rest of the scene. This live video feed can be in the form of a three-dimensional reconstruction of the scene, combined with head tracking and viewer dependent rendering, so that the three-dimensional rendering of the scene matches what a viewer would see if the display were transparent.

The live video feed can be displayed in a semi-opaque manner so that objects can be easily overlaid on the scene without confusion to the viewer. Displaying the scene in a semi-opaque manner can be done with with an optically shuttered transparent display, such as a liquid crystal display. Alternatively, if the display is emissive, such as an (OLED) on a transparent substrate, then the emissive pixels are made bright enough to blend naturally into the scene and be visible.

A computer program (not shown) generates and displays simulated objects 106 in a display area 108. The computer program can be run on a processor built into the display or on a computer connected to the display. The simulated objects 106 correspond to objects, e.g., object 112, in the scene 102.

The simulated objects, in general, are defined by the computer from image data of the scene. In particular, image data of the scene is received into memory in the computer. The image data is received from one or more cameras (not shown) in a known relationship with a display 104. A camera may be on the same housing as the display, or may be positioned in an environment containing the scene 102. The computer system generates models, such as three-dimensional models defined by vertices, edges and surfaces, of actual objects in the scene. The models are thus simulated objects corresponding to the actual objects in the scene.

The simulated objects are rendered and displayed on the display. As will be described in more detail below, these simulated objects, and any live video feed of the scene, are displayed based on the viewer's orientation with respect to the display and the orientation of the display with respect to the scene. Thus, the simulated objects appear on the display to the viewer as if they are in substantially the same place as the actual objects in the scene. The viewer orientation and display orientation can be detected by any of a variety of sensors and cameras, as described in more detail below. As a result, as a viewer moves, or as the display moves, the displayed simulated objects, and any live video feed of the scene, are reoriented, scaled, rendered and displayed, to maintain the appearance of the simulated objects overlapping their corresponding actual objects.

Given a display with one or more simulated objects, the displayed objects can be manipulated spatially on the display through various user gestures. One kind of manipulation is selection of an object. If the display is touch sensitive or supports use of a stylus, then an object can be selected by an individual touching the object with a finger or stylus. Alternatively, a gesture detection interface based on imaging can be used to detect gestures of an object, for example of a hand, between the display and the scene. If the display is transparent or semi-transparent, the hand can be seen through the display and can appear to be manipulating objects directly in the scene.

Given a selected object, a variety of other operations can be performed on that object. For example, a designer can visually simulate a redesign of the space in many ways. The designer can, for example, add selected objects, remove objects, rearrange existing objects, or change properties of those objects.

Regarding adding objects, as described in more detail below, a library of objects can be provided that can be selected and placed into the virtual scene. An object can be positioned in the scene and then scaled appropriately to fit the scene. Similarly, a selected object can be repositioned in the scene, and then scaled and rotated appropriately to fit the scene.

Regarding changing properties of objects, as described in more detail below, there are many properties of the rendering of objects that can be manipulated. For example, color, texture or other surface properties, such as reflectance, of an object, or environmental properties, such as lighting, that affect the appearance of an object, can be changed. The object also can be animated over time. For example, the object can by its nature be movable, or can grow, such as a plant.

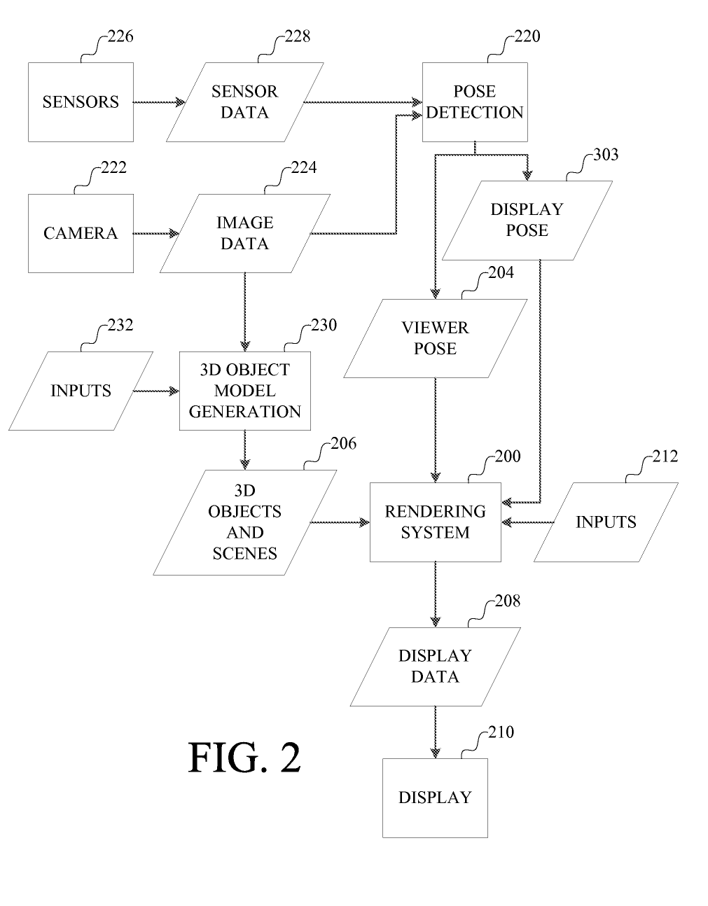

Given this context, an example implementation of a computer system supporting such a design application will be described in more detail in connection with FIG. 2.

In FIG. 2, a data flow diagram illustrates an example implementation. At the center of this design application is a rendering system 200 which receives information about the display pose 202 and the viewer pose 204, along with data 206 describing three dimensional objects and a scene to be rendered. The display pose 202 defines the position and orientation of the display device with respect to the scene. The viewer pose defines the position and orientation of the viewer with respect to the display device. The rendering system 200 uses the inputs 202, 204 and 206 to render the display, causing display data 208 to be displayed on the display 210.

The rendering system also can use other inputs 212 which affect rendering. Such inputs can include, but are not limited to, position and type of lighting, animation parameters for objects, texturing and colors of objects, and the like. Such inputs are commonly used in a variety of rendering engines designed to provide realistic renderings such as used in animation and games.

A pose detection module 220 uses various sensor data to determine the display pose 202 and viewer pose 204. In practice, there can be a separate pose detection module for detecting each of the display pose and viewer pose. As an example, one or more cameras 222 can provide image data 224 to the pose detection module 220. Various sensors 226 also can provide sensor data 228 to the pose detection module 220.

The camera 222 may be part of the display device and be directed at the viewer. Image data 224 from such a camera 222 can be processed using gaze detection and/or eye tracking technology to determine a pose of the viewer. Such technology is described in, for example, “Real Time Head Pose Tracking from Multiple Cameras with a Generic Model,” by Qin Cai, A. Sankaranarayanan, Q. Zhang, Zhengyou Zhang, and Zicheng Liu, in IEEE Workshop on Analysis and Modeling of Faces and Gestures, in conjunction with CVPR 2010, June 2010, and is found in commercially available products, such as the Tobii IS20 and Tobii IS-1 eye trackers available from Tobii Technology AB of Danderyd, Sweden.

The camera 222 may be part of the display device and may be directed at the environment to provide image data 224 of the scene. Image data 224 from such a camera 222 can be processed using various image processing techniques to determine the orientation of the display device with respect to the scene. For example, given two cameras, stereoscopic image processing techniques, such as described in “Real-Time Plane Sweeping Stereo with Multiple Sweeping Directions”, Gallup, D., Frahm, J.-M., et al., in Computer Vision and Pattern Recognition (CVPR) 2007, can be used to determine various planes defining the space of the scene, and the distance of the display device from, and its orientation with respect to, various objects in the scene, such as described in “Parallel Tracking and Mapping for Small AR Workspaces”, by Georg Klein and David Murray, in Proc. International Symposium on Mixed and Augmented Reality (ISMAR'07), and “Visual loop closing using multi-resolution SIFT grids in metric-topological SLAM”, Pradeep, V., Medioni, G., and Weiland, J., in Computer Vision and Pattern Recognition (CVPR) 2009, pp. 1438-1445, June 2009.

Images from camera(s) 222 that provide image data 224 of the scene also input this image data to an object model generator 230. Object model generator 230 outputs three dimensional models of the scene (such as its primary planes, e.g., floors and walls), and of objects in the scene (such as furniture, plants or other objects), as indicated by the object model at 240. Each object that is identified can be registered in a database with information about the object including its location in three-dimensional space with respect to a reference point (such as a corner of a room). Using the database, the system has sufficient data to place an object back into the view of the space and/or map it and other objects to other objects and locations.

Various inputs 232 can be provided to the object model generator 230 to assist in generating the object model 206. In one implementation, the object model generator 230 processes the image data using line or contour detection algorithms, examples of which are described in “Egomotion Estimation Using Assorted Features”, Pradeep, V., and Lim, J. W., in the International Journal of Computer Vision, Vol. 98, Issue 2, Page 202-216, 2012. A set of contours resulting from such contour detection is displayed to the user (other intermediate data used to identify the contours can be hidden from the user). In response to user input 232, indicating selected lines, the user input can be used to define and tag objects with metadata describing such objects. It can be desirable to direct the user through several steps of different views of the room, so that the user first identifies the various objects in the room before taking other actions.

A user can select an object in the scene or from a model database to add to the scene. Given a selected object, the position, scale and/or orientation of the object can be changed in the scene. Various user gestures with respect to the object can be used to modify the displayed object. For example, with the scene displayed on a touch-sensitive display, various touch gestures, such as a swipe, pinch, touch and drag, or other gesture can be used to rotate, resize and move an object. A newly added object can be scaled and rotated the match size and orientation of objects in the scene.

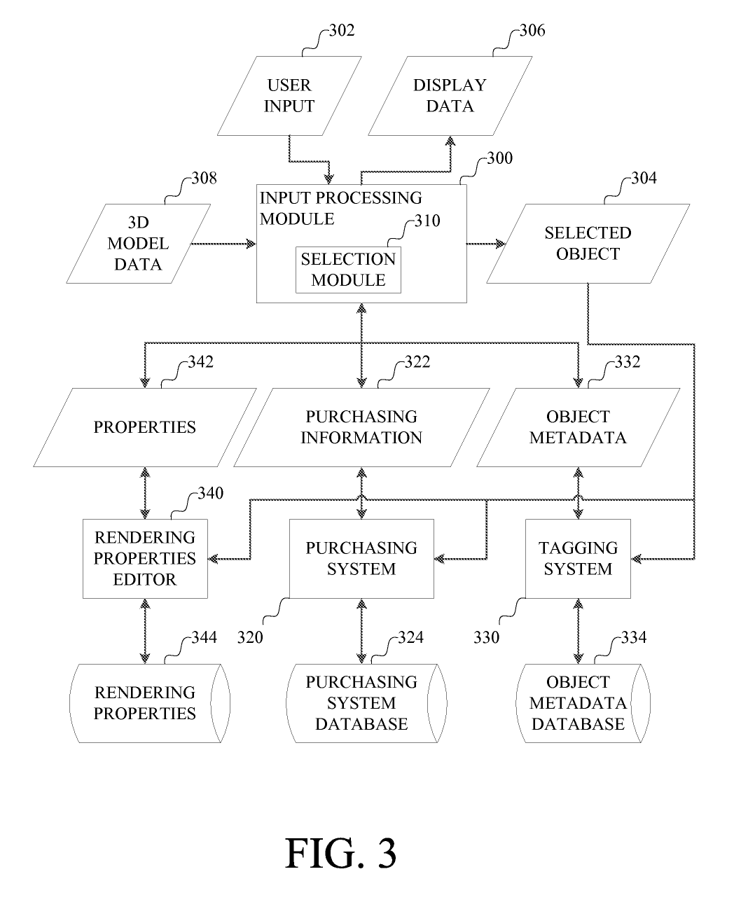

Also, given a selected object, items can be purchased, various properties can be changed, and metadata can be added and changed. Referring to FIG. 3, an input system that manages other inputs related to selected objects will now be described.

The input processing module 300 in FIG. 3 receives various user inputs 302 related to a selected object 304. The display data 306 corresponds to the kind of operation being performed by the user on the three-dimensional scene 308. For example, when no object is selected, the display data 306 includes a rendering of the three-dimensional scene 308 from the rendering engine. User inputs 302 are processed by a selection module 310 to determine whether a user has selected an object. Given a selected object 304, further inputs 302 from a user direct the system to perform operations related to that selected object, such as editing of its rendering properties, purchasing related goods and services, tagging the object with metadata, or otherwise manipulating the object in the scene.

In FIG. 3, a purchasing module 320 receives an indication of a selected object 306 and provides information 322 regarding goods and services related to that object. Such information can be retrieved from one or more databases 324. As described below, the

selected object can have metadata associated with it that is descriptive of the actual object related to the selected object. This metadata can be used to access the database 324 to obtain information about goods and services that are available. The input processing module displays information 322 as an overlay on the scene display adjacent the selected object, and presents an interface that allows the user to purchase goods and services related to the selected object.

A tagging module 330 receives an indication of a selected object 306 and provides metadata 332 related to that object. Such data is descriptive of the actual object related to the simulated object. Such information can be stored in and retrieved from one or more databases 334. The input processing module 300 displays the metadata 332 and presents an interface that allows the user to input metadata (whether adding, deleting or modifying the metadata). For an example implementation of such an interface, see “Object-based Tag Propagation for Semi-Automatic Annotation of Images”, Ivanov, I., et al., in proceedings of the 11th ACM SIGMM International Conference on Multimedia Information Retrieval (MIR 2010).

A rendering properties editor 340 receives an indication of a selected object 306 and provides rendering information 342 related to that object. Such information can be stored in and retrieved from one or more databases 344, such as a properties file for the scene model or for the rendering engine. The input processing module 300 displays the rendering properties 342 and presents an interface that allows the user to input rendering properties for the selected object or the environment, whether by adding, deleting or modifying the rendering properties. Such properties can include the surface properties of the object, such as color, texture, reflectivity, etc., or properties of the object, such as its size or shape, or other properties of the scene, such as lighting in the scene.

As an example, the rendering properties of the selected object can be modified to change the color of the object. For example, a designer can select a chair object and show that chair in a variety of different colors in the scene. As another example, the designer can select the chair object and remove it from the scene, thus causing other objects behind the removed object to be visible as if the selected object is not there.

These properties can be defined as a function over time to allow them to be animated in the rendering engine. As an example, lighting can be animated to show lighting at different times of day. An object can be animated, such as a tree or other object that can change shape over time, to illustrate the impact of that object in the scene over time.

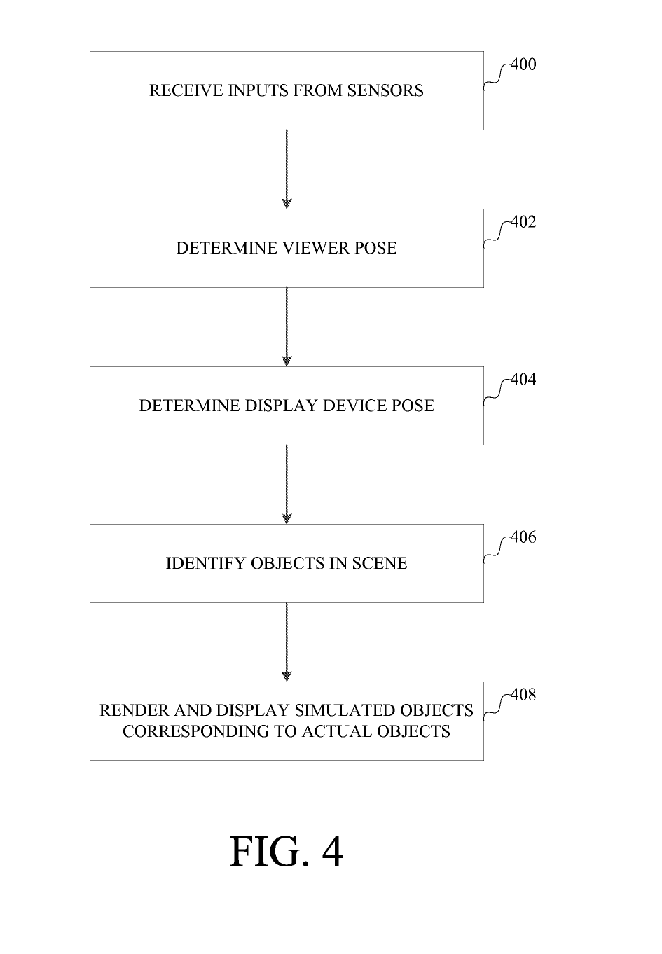

Referring now to FIG. 4, a flow chart describing the general operation of such a system will now be described. First, inputs from one or more cameras and/or one or more sensors are received 400 from the scene. Such inputs are described above and are used determining 402 the pose of the viewer with respect to the display device, and determining 404 the pose of the display device with respect to the scene, as described above. Next, one or more objects within the scene are identified 406, such as through contour detection, whether automatically or semi-automatically, from which three dimensional models of simulated objects corresponding to those actual objects are generated. Given the determined poses and simulated objects, the simulated objects can be rendered and displayed 408 on the display in the scene such that simulated objects appear to the viewer to be in substantially a same place as the actual objects in the scene. As described above, in one implementation, such rendering is performed according to a view dependent depth corrected gaze.

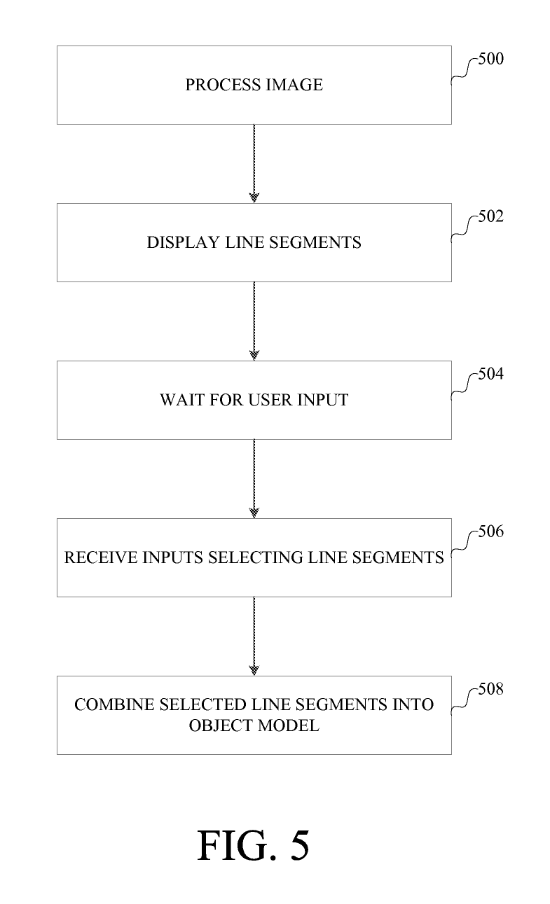

An example implementation of the operation of using contour detection to generate the simulated models of objects in a scene will now be described in connection with FIG. 5. Given a scene, an image is processed 500, for example by using convention edge detection techniques, to identify contours of objects in the scene. Edge detection typically is based on finding sharp changes in color and/or intensity in the image. As a result, edges are identified, each of which can be defined by one or more line segments. Each line segment can be displayed 502 on the display, and the system then waits 504 for user input. The system then receives 506 user inputs indicating a selection of one or more line segments to define an object. When completed, the selected line segments are combined 508 into a three dimensional object. The process can be repeated, allowing the user to identify multiple objects in the scene.

Having now described the general architecture of such a design system, an example use case for the design system will now be described.

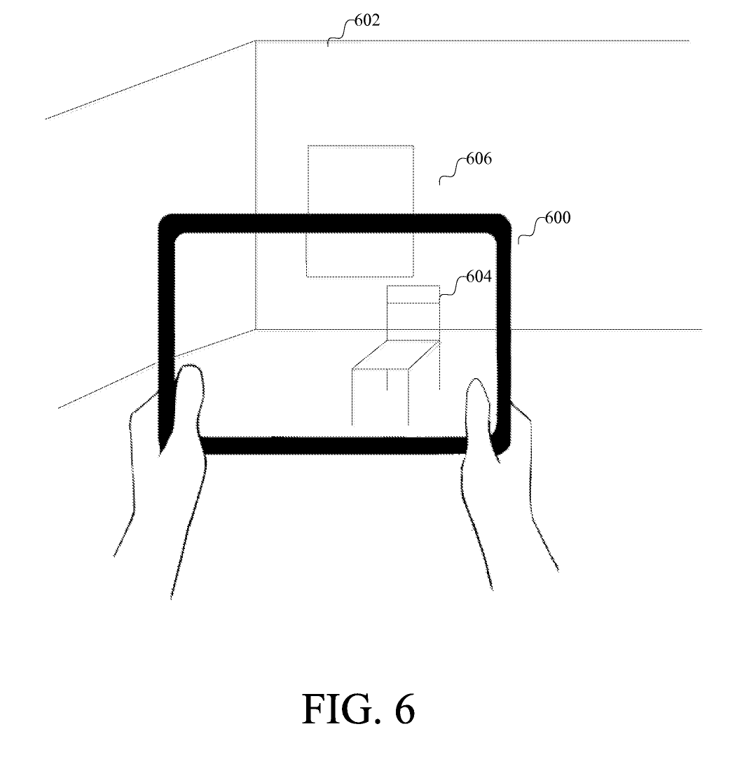

A user is interested in redesigning and interior living space, such as a bedroom or dining room, or exterior living space, such as a patio or deck. Using this design system, the user takes a position in the room, and holds the display in the direction of an area of the living space to be redesigned. For example, the user may look at a corner of a bedroom that has a few pieces of furniture. For example, as shown in FIG. 6, the user holds display 600, directed at a corner of a room 602. The scene includes a chair 604. Note that the view of the scene on or through the display 600 is in the context of the actual scene 606. After activating the design system, the design system performs object recognition, such as through contour analysis, prompting the user to identify objects in the displayed scene. After identifying objects in the scene, the design system renders and displays simulated objects, such as the chair 604, corresponding to the actual objects, such that they appear to the viewer to be in substantially a same place as the actual objects in the scene. The user can tag the objects by selecting each object and adding metadata about the object. For example, the user can identify the chair 604, and any other objects in the room, such as a chest of drawers (not shown), a nightstand (not shown) and a lamp (not shown) in the corner of the bedroom, and provide information about these objects.

If the user decides to change the chair and deletes its simulated object from the scene, the design system can gray out the chair object in the displayed scene. The user can access a library of other chair objects and selects a desired chair, placing it in the scene. The user then can select the rendering properties of the chair, selecting a kind of light for it, and animation of the light being turned off and on.

The user can decides to change other aspects of the scene (not shown in FIG. 6). For example, the user can change the finish of the chest of drawers and nightstand by selecting each of those objects, in turn. After selecting an object, the user selects and edits its rendering properties to change its color and/or finish. For example, the user might select glossy and matte finishes of a variety of colors, viewing each one in turn.

As noted above, the user views the design changes to the living space on the display, with the scene rendered such that simulated objects appear to the viewer to be in substantially a same place as the actual objects in the scene. Thus, the viewer also sees the scene in the context of the rest of the living space outside of the view of the display.

After viewing the design modifications to the living space, the user then selects the purchasing options for each of the objects that have been changed. For example, for the chair the design system can present a store interface for the selected chair. The design system can present a store interface for purchasing furniture matching the new design, or can present the user with service options such as furniture refinishing services.

Having now described an example implementation, a computing environment in which such a system is designed to operate will now be described. The following description is intended to provide a brief, general description of a suitable computing environment in which this system can be implemented. The in-scene design system can be implemented with numerous general purpose or special purpose computing hardware configurations. Examples of well known computing devices that may be suitable include, but are not limited to, tablet or slate computers, mobile phones, personal computers, server computers, hand-held or laptop devices (for example, notebook computers, cellular phones, personal data assistants), multiprocessor systems, microprocessor-based systems, set top boxes, game consoles, programmable consumer electronics, network PCs, minicomputers, mainframe computers, distributed computing environments that include any of the above systems or devices, and the like.

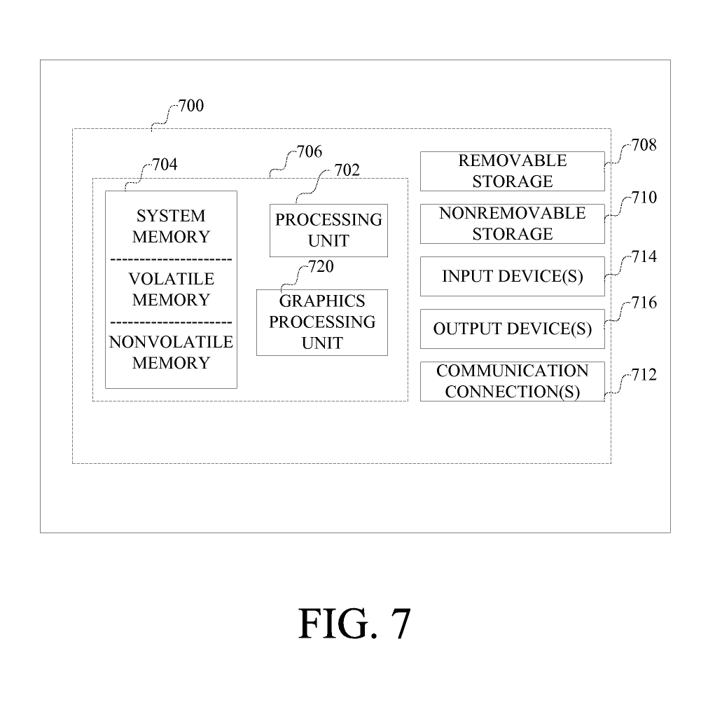

FIG. 7 illustrates an example of a suitable computing system environment. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 7, an example computing environment includes a computing machine, such as computing machine 700. In its most basic configuration, computing machine 700 typically includes at least one processing unit 702 and memory 704. The computing device may include multiple processing units and/or additional co-processing units such as graphics processing unit 720. Depending on the exact configuration and type of computing device, memory 704 may be volatile (such as RAM), non-volatile (such as ROM, flash memory, etc.) or some combination of the two. This most basic configuration is illustrated in FIG. 7 by dashed line 706. Additionally, computing machine 700 may also have additional features/functionality. For example, computing machine 700 may also include additional storage (removable and/or non-removable) including, but not limited to, magnetic or optical disks or tape. Such additional storage is illustrated in FIG. 7 by removable storage 708 and non-removable storage 710. Computer storage media includes volatile and nonvolatile, removable and non-removable media implemented in any method or technology for storage of information such as computer program instructions, data structures, program modules or other data. Memory 704, removable storage 708 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 700. Any such computer storage media may be part of computing machine 700.

Computing machine 700 may also contain communications connection(s) 712 that allow the device to communicate with other devices. Communications connection(s) 712 include(s) an example of communication media. Communication media typically carries computer program instructions, data structures, program modules or other data in a modulated data signal such as a carrier wave or other transport mechanism and includes any information communication media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 700 may have various input device(s) 714 such as a keyboard, mouse, pen, camera, touch input device, and so on. In this in-scene design system, the inputs also include one or more video cameras. Output device(s) 716 such as a display, speakers, a printer, and so on may also be included. All of these devices are well known in the art and need not be discussed at length here.

The input and output devices can be part of a natural user interface (NUI). NUI may be defined as any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence. Example categories of NUI technologies include, but are not limited to, touch sensitive displays, voice and speech recognition, intention and goal understanding, motion gesture detection using depth cameras (such as stereoscopic camera systems, infrared camera systems, RGB camera systems and combinations of these), motion gesture detection using accelerometers, gyroscopes, facial recognition, 3D displays, head, eye , and gaze tracking, immersive augmented reality and virtual reality systems, all of which provide a more natural interface, as well as technologies for sensing brain activity using electric field sensing electrodes (EEG and related methods).

This design system may be implemented in the general context of software, including computer-executable instructions and/or computer-interpreted instructions, such as program modules, stored on a storage medium and being processed by a computing machine. Generally, program modules include routines, programs, objects, components, data structures, and so on, that, when processed by a processing unit, instruct the processing unit to perform particular tasks or implement particular abstract data types. This system may be practiced in distributed computing environments where tasks are performed by remote processing devices that are linked through a communications network. In a distributed computing environment, program modules may be located in both local and remote computer storage media including memory storage devices.

Given the various modules in FIGS. 2 and 3, any of the connections between the illustrated modules can be implemented using techniques for sharing data between operations within one process, or between different processes on one computer, or between different processes on different processing cores, processors or different computers, which may include communication over a computer network and/or computer bus. Similarly, steps in the flowcharts can be performed by the same or different processes, on the same or different processors, or on the same or different computers.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
receiving image data of a scene into memory, the image data being received from one or more cameras in a known relationship with a display;
generating models of actual objects in the scene, the models defining simulated objects corresponding to the actual objects in the scene;
detecting a viewer's orientation with respect to the display; and
rendering the simulated objects on the display such that the simulated objects appear to the viewer to be in substantially a same place as the actual objects in the scene and such that the displayed simulated objects are can be manipulated spatially on the display through user gestures.

2. The computer-implemented process of claim 1, wherein generating models of actual objects comprises:
detecting contours of an actual object in the image data; and
converting the detected contours into a simulated object corresponding to the actual object.

3. The computer-implemented process of claim 2, wherein generating models of actual objects comprises:
receiving input from a user selecting the detected contours that define the actual object.

4. The computer-implemented process of claim 3, further comprising receiving data descriptive of the actual object and storing the received data in association with the corresponding simulated object.

5. The computer-implemented process of claim 1, wherein rendering the simulated objects on the display such that the simulated objects appear to the viewer to be in substantially a same place as the actual objects in the scene, comprises rendering the simulated objects according to a view dependent depth corrected gaze.

6. The computer-implemented process of claim 1, further comprising:
modifying a displayed simulated object in response to a user gesture with respect to the display.

7. The computer-implemented process of claim 1, further comprising:
associating items available for purchase with the simulated objects.

8. The computer-implemented process of claim 7, further comprising:
receiving information describing a purchase of an item associated with a simulated object.

9. The computer-implemented process of claim 1, wherein rendering the simulated objects on the display such that the simulated objects appear to the viewer to be in substantially a same place as the actual objects in the scene, comprises:
generating a three-dimensional model of the scene;
determining a pose of the display with respect to the scene;
determining a pose of the viewer with respect to the display; and
rendering the scene on the display according to the determined poses of the display and the viewer.

10. The computer-implemented process of claim 1, further comprising:
simulating changes in a simulated object over time.

11. The computer-implemented process of claim 1, further comprising:
adding a simulated object to the display in response to a user gesture.

12. The computer-implemented process of claim 1, further comprising:
scaling and rotating the simulated object to match size and orientation of objects in the scene.

13. The computer-implemented process of claim 1, further comprising:
simulating changes in lighting on the simulated objects displayed on the display.

14. The computer-implemented process of claim 1, further comprising:
simulating changes in surface properties of the simulated objects displayed on the display.

15. An article of manufacture comprising:
computer storage;
computer program instructions stored on the computer storage which, when processed by a processing device, instruct the processing device to perform a process comprising:
receiving image data of a scene into memory, the image data being received from one or more cameras in a known relationship with a display;
generating models of actual objects in the scene, the models defining simulated objects corresponding to the actual objects in the scene;
detecting a viewer's orientation with respect to the display; and
rendering the simulated objects on the display such that the simulated objects appear to the viewer to be in substantially a same place as the actual objects in the scene and such that the displayed simulated objects can be manipulated spatially on the display through user gestures.

16. The article of manufacture of claim 15, wherein the process further comprises:
modifying a displayed simulated object in response to a user gesture with respect to the display.

17. The article of manufacture of claim 15, wherein the process further comprises:
associating items available for purchase with the simulated objects.

18. A design system comprising:
inputs for receiving image data of a scene;
an object modeling system having inputs for receiving data describing the scene and an output providing simulated objects corresponding to actual objects in the scene;
a rendering system having inputs for receiving the simulated objects and outputting to a display a rendering of the scene such that simulated objects appear to the viewer to be in substantially a same place as the actual objects in the scene; and
an input system enabling a user to spatially manipulate the displayed simulated objects on the display.

19. The design system of claim 18, further comprising:
an input system that processes user input with respect to one or more simulated objects and modifies one or more properties of the simulated objects.

20. The design system of claim 18, further comprising:
a purchasing system that processes user input with respect to one or more simulated objects and presents goods or services available for purchase related to the simulated objects.
